(19) United States
(12) Patent Application Publication
(10) Pub. No.: US 2007/0085341 A1
(43) Pub. Date: Apr. 19, 2007

(54) Pipe coupling

(76) Inventors: Owen Walmsley, Invernesshire (GB); Robert Emmett, Lancaster (GB)

Correspondence Address: Samuels, Gauthier & Stevens LLP, Suite 3300, 225 Franklin Street, Boston, MA, 02110, US

(21) Appl. No.: 10/459,008

(22) Filed: Jun. 11, 2003

Related U.S. Application Data
(63) Continuation of application No. PCT/GB01/05497, filed on Dec. 13, 2001.

(30) Foreign Application Priority Data
Dec. 14, 2000 (GB) 0030472.5

(51) Int. Cl. F16L 21/02

(52) U.S. Cl. 285/369; 285/417; 285/420

(57) ABSTRACT

A coupling for joining and maintaining in close relationship two aligned rods or pipes and to prevent them from separating but which is of reduced outer diameter and weight when compared with conventional couplings, comprising a pair of annular sleeves to be located respectively round a pair of aligned pipe end regions and movable relatively along the latter, ball ramp arrangements for gripping the outer circumferential surface of the respective pipe end regions, a split sleeve adapted to surround the annular sleeves while being anchored to one sleeve and threadedly engaged on the other sleeve thus, by rotation, to draw the sleeves together to grip the pipe ends. Temporary clamping means comprising split flanges and draw bolts with nuts, are provided initially to draw the coupling together, but are removable after the split sleeve has been placed in axial tension.

THIS INVENTION concerns couplings adapted to join and maintain, in close relationship, two aligned rods or pipes and prevent them from separating.

Typically, pipe couplings include relatively large diameter flanged members which grip the respective pipe end regions and which are held together by bolts. It is an object of the present invention to reduce considerably the outer diameter and weight of such couplings particularly for applications in which pipe ends must be joined without cumbersome and excessively heavy coupling assemblies.

According to the present invention, there is provided a coupling comprising a par of annular sleeves to be located respectively around a pair of aligned pipe end regions and movable relatively along the longitudinal axis of the coupling, means associated with each annular sleeve for gripping the outer circumferential surface of a respective pipe end region, a split sleeve adapted commonly to surround the annular sleeves and means to place the split sleeve in axial tension thus to force the annular sleeves together to maintain a grip on the pipe end regions and prevent them from separating.

The split sleeve may be ably adjustable relative to at least one of the annular sleeves.

The split sleeve may be threadedly engaged with at least one of the annular sleeves thus to be axially adjustable relative thereto.

The split sleeve may be rotationally mounted on at least one of the annular sleeves but immovable axially thereon.

A third annular sleeve may be disposed between said two annular sleeves and have sealing engagement with the outer circumferential surfaces of the respective pipe end regions.

The gripping means of each annular sleeve may be a ball and ramp arrangement adapted to grip the outer circumferential surface of the associated pipe end region as the two annular sleeves are drawn together.

Of the bell and ramp arrangement the ball may be selected to be of a harder material than the pipe thus to form a non-reversible indentation in the latter as the annular sleeves are drawn together.

The split sleeve may have at least one recess to receive a bar to enable rotation of the split sleeve.

Clamping may be provided to draw the annular sleeves together axially, said clamping means being removable once the split sleeve has been placed in axial tension.

The clamping means may comprise a removable pair of split flanges to be located one at each end of the coupling and adapted to receive draw bolts for temporarily maintaining the coupling as the annular sleeves are drawn together.

The threaded engagement of the split sleeve on at least one of the annular sleeves may have a reverse taper to ensure that the opposed threaded members are maintained in engagement.

The means to place the split sleeve in axial tension may be a nut threadedly engaged on one of the annular sleeves.

The threaded engagement of the nut on one of the annular sleeves may have a reverse taper to ensure that the opposed threaded members are maintained in engagement.

An embodiment of the invention will now be described by way of example only, with reference to the accompanying drawings, in which:—

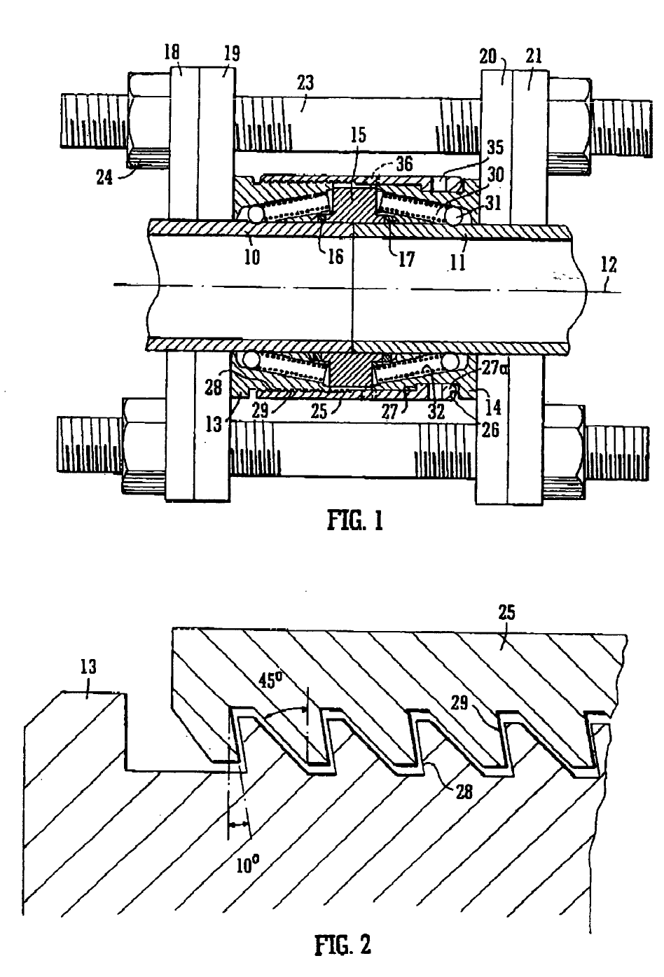

FIG. 1 is a part cross-sectional view of a pipe coupling according to a first embodiment of the present invention when applied to the joining of a pair of aligned pipe ends;

FIG. 2 is an enlarged schematic cross-sectional view of a part of the coupling assembly illustrated in FIG. 1;

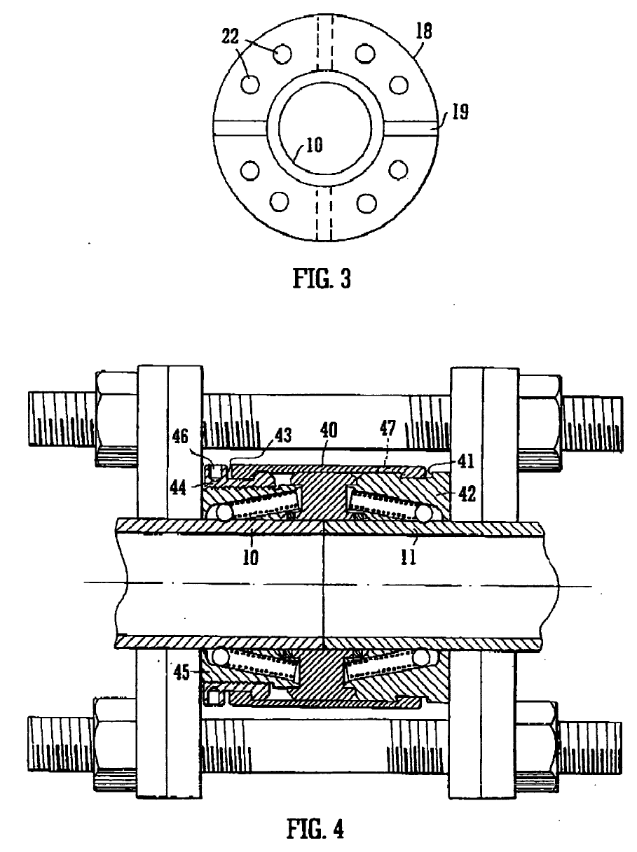

FIG. 3 is an end view of the coupling of FIG. 1;

and FIG. 4 is a view similar to FIG. 1 of a second embodiment.

Referring now the drawings, a pipe coupling made in accordance with the first embodiment when applied to the junction of an aligned pair of pipe ends 10 and 11 having a common longitudinal axis 12 comprises a pair of annular sleeves 13 and 14 and a separate sleeve member 15 having resilient sealing rings 16 and 17. Sleeves 13, 14 and 13 are slid onto the pipes before they are joined (as shown in FIG. 1) so that they may be brought together in a close assembly in the region of the pipe joint. A first pair of split flanges 18 and 19 is also located on pipe 10 behind sleeve 13 and a second similar pair of flanges 20 and 21 is placed on the pipe 11 behind sleeve 14. As can be seen in FIG. 3, each of the flanges 18, 19, 20 and 21 is comprised of two semi-circular half flanges each with an array of holes 22 arranged around a central arc of the half flange. The half flanges of each pair 18, 19 and 20, 21 are arranged such that their splits are offset by 90° so that, for example, the split of flange 18 will lie horizontally in relation to the assembly of FIG. 1 while that of the flange 19 will lie vertically.

Bolts 23 and nuts 24 serve to draw the flanges 18, 19, 20 and 21 towards each other thus urging the sleeves 13, 14 and 15 into close engagement around the pipe joint.

A split sleeve 25 which is of generally cylindrical form but has a longitudinal slit at one position around its circumference, is located party in a recess 26 of the annular sleeve 14, the recess being of outwardly tapering wall form at 27 i.e. at its inner end thus to anchor an inwardly enlarged boss 27a of the split sleeve 25 within the recess 26. The left-hand end region of sleeve 25, when viewed in FIG. 1, is internally threaded at 29 to engage the equal tad 28 of annular sleeve 13.

Each annular sleeve 13, 14 has, around its circumference, a plurality of inclined ball slots 30 in which a ball tightened. This is necessary in view of the split nature of the sleeve 25.

In the assembly of the coupling, once the parts are located on the pipe ends and the pips arm brought together then the bolts 23 are tightened initially to draw the annular sleeves 13, 14 and 15 into close contact over the centre line of the pipe joint. This has the effect of causing the balls 31 to grip the pipe walls thus preventing them from separating. During this assembly step, the split sleeve 25 will ride over the external thread of annular sleeve 13 owing to the ratchet effect of the inclined teeth of the threads and by virtue of the split nature of the sleeve 25.

The coupling is finally tightened by rotation of the split sleeve 25 (by inserting one or more tommy bars in the bores 35) until any slack in the parts of the coupling are taken up. Once the coupling is tightened in this way the flanges 18, 19, 20 and 21 and the bolts 23 and nuts 24 can be removed leaving a reduced weight and a reduced diameter coupling defined by the sleeves 13, 14 and 15 and the split sleeve 25.

To dismantle the coupling it is necessary to re-attach and tighten the temporary bolts and flanges in order to back off the load from the threaded split sleeve before it can be removed using jacking screws inserted in the tapped bores 36.

Referring now to FIG. 4, in an alternative arrangement, the split sleeve 40 is anchored at both of its ends respectively in an annular recess 41 in annual sleeve 42 and an annular recess 43 in a nut 44 threadedly engaged upon the other annular sleeve 45, In this case, the nut 44 is provided with a plurality of bores 46 into which one or more tommy bars may be inserted for tightening. It will be seen, that in this embodiment the split sleeve 40 is placed under tension not by its threaded relationship with one of the annular sleeves but by its anchored relationship with the nut 44 which in turn is threadedly engaged on the annular sleeve 45. Once again, the external flanges and bolts are used to pre-assemble the coupling before it is finally tightened using nut 44 to place the split sleeve 40 under tension.

Once again, the split sleeve 40 has a number of tapped bores 47 for the insertion of jacking screws for the removal of the split sleeve 40 when the coupling is to be dismantled, the tension in the sleeve 40 having been relieved by reintroduction of the removable flanges ad bolts.

It is not intended to limit the invention to the above details. For example, a solid rod or, for example, a drive shaft may be joined by such a coupling which therefore has minimal radial extent and reduced balancing requirements. Any close-coupled means may be provided for axially tensioning the split sleeve; and the split sleeve may be replaced by a plurality of axial ties.

1. A coupling comprising a pair of annular sleeves to be located respectively around a pair of aligned pipe end regions and movable relatively along the longitudinal axis of the coupling, means associated with each annular sleeve for gripping the outer circumferential surface of a respective pipe end region, a longitudinal split sleeve adapted commonly to surround the annular sleeves and means to place the split sleeve in axial tension and to force the annular sleeves together to maintain a grip on the pipe end regions and prevent them from separating.

2. A coupling according to claim 1, wherein the split sleeve is axially adjustable relatively to at least one of the annular sleeves.

3. A coupling according to claim 1, wherein the split sleeve is threadedly engaged with at least one of the annular sleeves thus to be axially adjustable relative thereto.

4. A coupling according to claim 1, wherein the split sleeve is rotationally mounted on at least one of the annular sleeves but immovable axially thereon.

5. A coupling according to claim 1, including a third annular sleeve disposed between said two annular sleeves and having sealing engagement with the outer circumferential surfaces of the respective pipe end regions.

6. A coupling according to claim 1, wherein the gripping means of each annular sleeve is a ball and ramp arrangement adapted to grip the outer circumferential surface of the associated pipe end region as the two annular sleeves are drawn together.

7. A coupling according to claim 6, wherein, of the ball and ramp arrangement, the ball is selected to be of harder material than the pipe thus to form a non-reversible indentation in the latter as the annular sleeves are drawn together.

8. A coupling according to claim 1, wherein the split sleeve has at least one recess to receive a bar to enable rotation of the split sleeve.

9. A coupling according to claim 1, including clamping means to draw the annular sleeves together axially, said clamping means being removable once the split sleeve has been placed in axial tension.

10. A coupling according to claim 9, wherein the clamping means comprises a removable pair of spilt flanges to be located one at each end of the coupling and adapted to receive draw bolts for temporarily maintaining the coupling as the annular sleeves are drawn together.

11. A coupling according to claim 3, wherein the threaded engagement of the split sleeve on at least one of the annular sleeves has a reverse taper to ensure that the opposed threaded members are maintained in engagement.

12. A coupling according to claim 1, wherein the means to place the split sleeve in axial tension is a nut threadedly engaged upon one of the annular sleeves.

13. A coupling according to claim 12, wherein the threaded engagement of the nut on one of the annular sleeves has a reverse taper to ensure that the opposed threaded members are maintained in engagement.
